(19) United States
(12) Patent Application Publication
(10) Pub. No.: US 2009/0139710 A1
(43) Pub. Date: Jun. 4, 2009

(54) SWELLABLE COMPOSITIONS AND METHODS AND DEVICES FOR CONTROLLING THEM

(75) Inventors: Agathe Robisson, Cambridge, MA (US); Partha Ganguly, Belmont, MA (US); Huilin Tu, Cambridge, MA (US); Tania Chan, Santa Ana, CA (US); Dominique Guillot, Somerville, MA (US); Kevin Forbes, Houston, TX (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Cambridge, MA (US)

(21) Appl. No.: 11/948,501

(22) Filed: Nov. 30, 2007

(51) Int. Cl. E21B 23/01; C08L 11/00; C08L 19/00; C08L 7/00

(52) U.S. Cl. 166/208; 525/215; 525/232; 525/237; 525/233; 525/55

(57) ABSTRACT

Swellable compositions and methods of using and controlling them are disclosed. In certain examples, the swellable composition may comprise an active phase responsive to swell upon exposure to a swelling fluid. In some examples, the active phase of the swellable composition is effective to deswell in response to an applied stimulus in the presence of the swelling fluid. In other examples, the swellable composition may further comprise a passive phase responsive to swell to a lesser degree than the active phase upon exposure to the swelling fluid. Devices and systems using the swellable compositions are also described.

### TECHNOLOGICAL FIELD

Examples disclosed herein relate generally to compositions effective to swell and deswell and to methods and systems using such compositions. More particularly, certain embodiments disclosed herein are directed to compositions whose swelling properties may be tuned or controlled through the use of one or more stimuli.

### BACKGROUND

In extraction of fuels from a potential fuel producing site, many difficulties exist in effectively removing the fuel. The fuel generally has to be extracted through a wellbore drilled into the earth's surface or crust. The devices and methods that are used downhole to extract the fuel generally require complex configurations involving a significant number of moving parts. Significant hydraulic pressures may be required to activate the devices downhole. In addition, the retrievability of the devices in many cases is difficult or impossible.

### SUMMARY

In accordance with a first aspect, a swellable composition is provided. In certain examples, the swellable composition comprises an active phase responsive to swell upon exposure to a swelling fluid, a passive phase responsive to swell to a lesser degree than the active phase upon exposure to the swelling fluid, and in which at least the active phase of the swellable composition is effective to swell or deswell in response to an applied stimulus in the presence of the swelling fluid.

In certain examples, the active phase comprises at least one elastomer. In other examples, the passive phase may be selected to provide structural integrity to the composition after swelling of the active phase. In some examples, the active phase may comprise one or more of neoprene, styrene butadiene rubber, ethylene-propylene-diene monomer (EPDM) rubber or natural rubber. In certain examples, the passive phase comprises one or more of hydrogenated butadiene rubber, homo- or co-polymers of 1,3-butadiene, styrene, isoprene, isobutylene, 2,3-dimethyl-1,3-butadiene, acrylonitrile, ethylene, propylene, fluoroelastomers or derivatives thereof. In additional examples, the composition may be effective to swell in the presence of a polar swelling fluid. In some examples, the composition may be effective to swell in the presence of a nonpolar swelling fluid. In other examples, the active phase may be effective to deswell in response to a chemical stimulus. In certain examples, the active phase may be effective to deswell in response to an electrical stimulus. In some examples, the active phase may be effective to deswell in response to a mechanical stimulus.

In accordance with another aspect, a swellable composition effective to remain deswelled in the presence of a swelling fluid, the composition comprising a pre-strained active phase that is responsive to swell in a non-strained state to provide a swollen composition is provided.

In certain embodiments, the composition may further comprise a passive phase effective to swell to a lesser degree than the active material in its non-strained state. In some examples, the pre-strained active phase may comprise an elastomer that has been strained during production of the elastomer to provide the pre-strained active phase. In other examples, the pre-strained active phase may comprise one or more of neoprene, styrene butadiene rubber, ethylene-propylene-diene monomer (EPDM) rubber or natural rubber. In certain examples, the passive phase may be selected to provide structural integrity to the composition after swelling of the active phase. In some examples, the composition may be effective to swell in the presence of a polar fluid in the non-strained state of the active phase. In additional examples, the composition may be effective to swell in the presence of a nonpolar fluid in the non-strained state of the active phase. In some examples, the swollen composition may swell or deswell in response to a chemical stimulus, an electrical stimulus or a mechanical stimulus.

In accordance with another aspect, a composition effective to swell in response to exposure to a swelling fluid to provide a swollen composition, the swollen composition effective to deswell in response to an external stimulus applied to the swollen composition in the presence of the swelling fluid is disclosed.

In certain examples, the composition may comprise an active phase whose swelling ratio increases in response to exposure of the swelling fluid. In some examples, the active phase may comprise at least one elastomer. In other examples, the composition may further comprise a passive phase whose swelling ratio increases by a lower amount in the presence of the swelling fluid than the increase in the swelling ratio of the active phase. In additional examples, the passive phase may be selected to provide structural integrity to the composition after swelling of the active phase. In some examples, the active phase may comprise one or more of neoprene, styrene butadiene rubber, ethylene-propylene-diene monomer (EPDM) rubber or natural rubber. In certain examples, the composition may be effective to swell in the presence of a polar swelling fluid. In other examples, the composition may be effective to swell in the presence of a nonpolar swelling fluid. In some examples, the active phase may be effective to deswell in response to a chemical stimulus, an electrical stimulus or a mechanical stimulus.

In accordance with an additional aspect, a composition effective to swell in response to exposure to a swelling fluid and in response to an external stimulus to provide a swollen composition, the swollen composition effective to deswell in response to an additional external stimulus applied to the swollen composition in the presence of the swelling fluid is provided.

In certain examples, the composition may comprise an active phase whose swelling ratio increases in response to exposure of the swelling fluid. In other examples, the active phase may comprise at least one elastomer. In additional examples, the composition may further comprise a passive phase whose swelling ratio increases by a lower amount in the presence of the swelling fluid than the increase in the swelling ratio of the active phase. In some examples, the passive phase may be selected to provide structural integrity to the composition after swelling of the active phase. In certain examples, the active phase may comprise one or more of neoprene, styrene butadiene rubber, ethylene-propylene-diene monomer (EPDM) rubber or natural rubber. In some examples, the composition may be effective to swell in the presence of a polar swelling fluid. In other examples, the composition may be effective to swell in the presence of a nonpolar swelling fluid. In certain examples, the active phase is effective to deswell in response to a chemical stimulus, an electrical stimulus or a mechanical stimulus.

In accordance with another aspect, a composition comprising at least a first domain effective to swell upon exposure to a swelling fluid and at least a second domain effective to swell to a lesser degree than the first domain upon exposure to the swelling fluid is disclosed.

In certain embodiments, the first domain may be one or more of a block copolymer. In some examples, the block copolymer may be an AB block copolymer, an ABA block copolymer, an ABC block copolymer or a star block copolymer. In other examples, the A, B and C units of the block copolymer may be independently selected from the group consisting of styrene, butadiene, isoprene, and neoprene. In some examples, A, B and C may be selected to be different. In certain examples, the second domain may comprise a synthetic or natural rubber. In other examples, the second domain may constrain swelling of the first domain. In some examples, the first domain may be effective to deswell in response to an external stimulus and in the presence of the swelling fluid. In other examples, the external stimulus may be a chemical stimulus, an electrical stimulus, or a mechanical stimulus. In certain examples, the swellable composition may be pre-strained to control swelling of the first domain in the presence of the swelling fluid. In some examples, the composition may further comprise an additive selected from the group consisting of carbon black, silica and a silicate.

In accordance with an additional aspect, a downhole tool is provided. In certain examples, the downhole tool comprises a swellable device comprising at least an active phase effective to swell in response to exposure to a swelling fluid to provide a swollen device, the active phase further configured to deswell in response to an external stimulus applied to the swellable device, and a support assembly coupled to the swellable device.

In certain examples, the tool may further comprise an inflatable bladder coupled to the support assembly. In some examples, the tool may comprise a device configured to apply the external stimulus to deswell the swollen device. In other examples, the device may be configured to apply a chemical stimulus, an electrical stimulus or a mechanical stimulus. In some examples, the device may be configured to apply a strain to the swellable device to keep the swellable device in a non-swollen state in the presence of the swelling fluid. In other examples, the swellable device of the tool may further comprise a passive phase that is configured to swell to a lesser degree than the active phase in the presence of the swelling fluid. In some examples, the swollen device may be effective to provide a seal. In certain embodiments, the seal may be broken by application of the external stimulus, the downhole tool may be repositioned at a location, and the external stimulus may be removed to permit swelling of the swellable device to provide a seal at the location. In other examples, the active phase may be configured as a polymeric material comprising a plurality of domains. In some examples, the passive phase may constrain swelling of the active phase.

In accordance with another aspect, a method of controlling swelling of a swellable composition comprising an active phase is provided. In certain examples, the method comprises applying a stimulus to the active phase of the swellable composition in the presence of a swelling fluid to control the swelling of the swellable composition, and removing the stimulus to allow the active phase of the swellable composition to swell.

In certain embodiments, the method may further comprise configuring the applied stimulus to be a chemical stimulus, an electrical stimulus or a mechanical stimulus. In some examples, the method may comprise exposing the swellable composition to a pH change. In other examples, the method may comprise exposing the swellable composition to a secondary fluid. In some examples, the applied electrical stimulus may be an electric field. In certain examples, the applied mechanical stimulus may be compression, strain or mechanical deformation. In some examples, the applied stimulus may control the rate at which the active phase swells. In other examples, the applied stimulus may control the degree to which the active material swells.

In accordance with an additional aspect, a method of controlling swelling of a swellable composition comprising an active material is provided. In certain examples, the method may comprise a first step comprising applying a stimulus to the active phase of the swellable composition in the presence of a swelling fluid to control the swelling of the swellable composition, and a second step following the first step and comprising removing the stimulus to allow the active phase of the swellable composition to swell.

In certain embodiments, the method may further comprise configuring the applied stimulus to be a chemical stimulus, an electrical stimulus or a mechanical stimulus. In some examples, the method may comprise exposing the swellable composition to a pH change. In other examples, the method may comprise exposing the swellable composition to a secondary fluid. In some examples, the applied electrical stimulus may be an electric field. In certain examples, the applied mechanical stimulus may be compression, strain or mechanical deformation. In some examples, the applied stimulus may control the rate at which the active phase swells. In other examples, the applied stimulus may control the degree to which the active material swells.

In accordance with another aspect, a method of controlling swelling of a swellable composition comprising an active material is disclosed. In certain examples, the method may comprise a first step comprising swelling a swellable material using a swelling fluid to provide a swollen material, and a second step following the first step and comprising deswelling the swollen material by applying a stimulus to the swollen material.

In certain embodiments, the method may further comprise configuring the applied stimulus to be a chemical stimulus, an electrical stimulus or a mechanical stimulus. In some examples, the method may comprise exposing the swellable composition to a pH change. In other examples, the method may comprise exposing the swellable composition to a secondary fluid. In some examples, the applied electrical stimulus may be an electric field. In certain examples, the applied mechanical stimulus may be compression, strain or mechanical deformation. In some examples, the applied stimulus may control the rate at which the active phase swells. In other examples, the applied stimulus may control the degree to which the active material swells.

In accordance with another aspect, a method of controlling swelling of a swellable composition comprising an active phase is disclosed. In certain examples, the method may comprise inducing strain in the swellable composition during manufacture of the swellable composition, and removing the strain in the swellable composition during use of the swellable composition to allow swelling of the swellable composition.

Additional aspects, examples, features and embodiments of the technology will be apparent to the person of ordinary skill in the art, given the benefit of the instant specification.

### BRIEF DESCRIPTION OF THE FIGURES

Certain features, aspect and examples are described in more detail below with reference to the accompanying figures in which:

FIG. 1 is graph showing the swelling ratio at different pH values for a composition, in accordance with certain examples;

FIG. 2A is a schematic showing two swellable packers before swelling and FIG. 2B is a schematic showing the same two swellable packers after swelling, in accordance with certain examples;

FIG. 3A is a schematic showing a swellable device before swelling and FIG. 3B is a schematic showing the swellable device after swelling, in accordance with certain examples;

FIG. 4 is a graph showing the swelling ratios of a material in the presence of two solvents, in accordance with certain examples; and

FIG. 5 is graph showing the effect of strain on the swelling ratio of various materials, in accordance with certain examples.

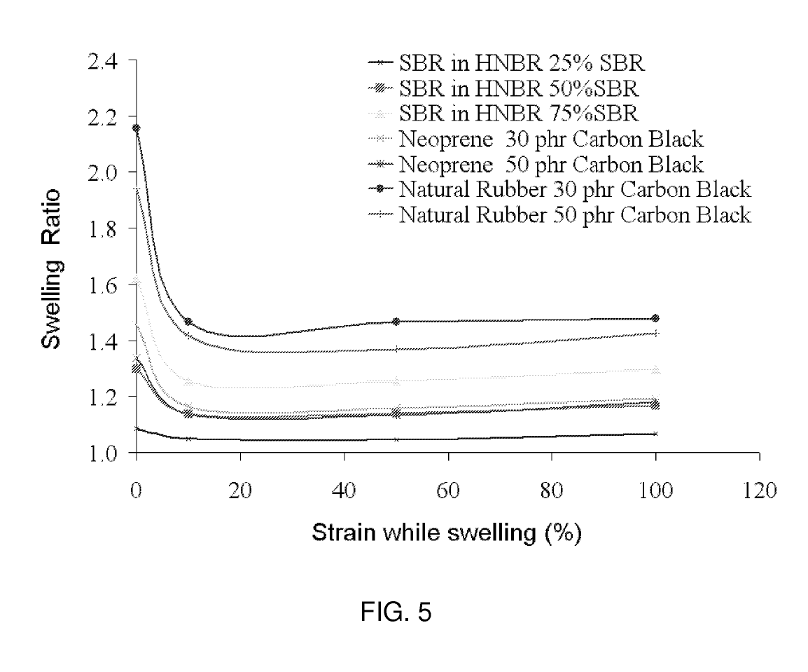

It will be recognized by the person of ordinary skill in the art, given the benefit of this disclosure, that certain dimension, features, components and the like in the figures may have been enlarged, distorted or otherwise shown in a non-proportional or non-conventional manner to facilitate a better understanding of the technology disclosed herein.

### DETAILED DESCRIPTION

Certain examples described herein provide significant advantages over existing materials including, but not limited to, tuning or control of the swelling characteristics of the material, in situ adjustment of the swelling characteristics, improved structural properties and improved sealing of spaces for extraction of fuels. These and other advantages will be recognized by the person of ordinary skill in the art, given the benefit of this disclosure.

In accordance with certain examples, the compositions disclosed herein are designed such that the swelling and deswelling of the compositions may be controlled. In some examples, the materials used in the compositions are selected to provide for “internal” control of the composition's swelling and deswelling. Such internal control may be referred to herein in certain instances as “zero order” control. In certain examples, a perturbation or stimulus may be applied either internally through structural constraints in the composition or externally through an applied stimulus. Such additional control may be referred to in certain instances herein as “first order” control. This control of the swelling and deswelling permits tuning of the composition's swollen volume and swelling rate. Other components may also be included in the compositions to provide additional control, e.g., second order or higher control.

In accordance with certain examples, the compositions disclosed herein may include one or more materials that are responsive to swell or deswell depending on the surrounding conditions. For example, in certain embodiments the compositions may swell in response to the presence of, or introduction of, a fluid. Similarly, the compositions may be designed such that the compositions deswell in response to the presence of, or introduction of, a fluid. In other examples, the swelling characteristics (or deswelling characteristics as the case may be) of the composition may be further controlled or tuned through design of the composition, through introduction of certain conditions or constraints in the composition itself, through the introduction of certain conditions or constraints in the use environment of the composition, through application of an external stimulus or perturbation to the composition or through other suitable devices or conditions that can provide for controlling or triggering the swelling and/or deswelling of the compositions.

In certain examples, the compositions disclosed herein are particularly suited for use in downhole tools and devices such as packers used in extraction of fuels through a wellbore. Packers are used downhole to isolate fluid producing regions, may be used in completion assemblies to suppress water production, and facilitate the production of oil and gas. Activating conventional packers downhole (e.g. setting a packer to seal the annulus between the production tubing and the casing or formation) can be quite complex. The packers are generally activated hydraulically using pressure. The completion assembly needs to include exclusive and complex set-ups involving pistons and valves that open and close to communicate pressure, mechanisms to communicate axial forces etc. to deploy the packer downhole. In addition, the complexity of the deployment mechanism can increase significantly if the packer is retrievable. Embodiments of the compositions, and methods and devices to control the swelling and deswelling of the compositions, are suitable for use in downhole tools and packer devices due to, for example, a simpler design, enhanced control and placement downhole, substantially improved sealing of spaces in a wellbore and other significant advantages.

In accordance with certain examples, the compositions disclosed herein may be effective to swell or deswell in the presence of a fluid. By selecting the material or materials for use in the compositions, the rate at which the compositions swell may be controlled. Fluid may diffuse throughout the network (or void space) of a material until an equilibrium state is reached. Swelling of the composition increases the overall size of the material(s) but may decrease the mechanical properties provided by the material. In certain embodiments disclosed herein, the equilibrium state of the compositions may be altered or otherwise shifted to reduce or increase the degree to which the compositions may swell to enhance or reduce selected physical properties of the composition. Such control or tuning of the rate and/or degree to which the compositions swell and deswell are discussed in more detail below.

In accordance with certain examples, the compositions disclosed herein may include only a single material, which may be referred to in certain cases herein as a unitary composition, whereas in other examples, the compositions disclosed herein may include two materials which may be referred to in certain cases herein as a binary composition. Depending on the exact chemical makeup, the unitary composition may have a single phase or may have two or more phases. Similarly, a binary composition may have a single phase or may have two or more phases. In some examples, the composition may include more than two materials. Such multi-component compositions may be referred to in certain instances herein as ternary compositions. In some configurations, the compositions disclosed herein may include two materials that have different structural arrangements within the composition, e.g., two monomers that have different arrangements in a polymer composition such as different monomeric units on different chains of the polymer. Illustrative forms of such multi-material and single and multiple phase compositions are discussed in more detail below.

In embodiments where a single material is present, the single material may be selected such that it is responsive to swell or deswell. In certain examples, the first material may be referred to in certain instances herein as including an active phase in that it is responsive to swell and deswell. As discussed further below, the active phase may be present by itself or may be used with one or more other materials which may include an active phase or a passive phase.

In certain embodiments where two or more materials are present, the properties of each material may be selected to provide differing physical properties. For example, a first material may be selected that some portion or all of it is responsive to swell or deswell, and a second material may be selected to impart mechanical strength to the composition. In some examples, some portion or all of the second material may also be responsive to swell or deswell but generally to a lesser degree than the first material. In other examples, the second material is generally non-responsive in that it does not substantially swell or deswell under the conditions used to induce swelling of the first material. In certain examples, the second material may be referred to in certain instances herein as including a passive phase in that is does not substantially swell or deswell, or it swells to a lesser degree than the first material. Examples of compositions that include active and passive phases are described in more detail below.

In accordance with certain examples, the materials selected for use to provide the phases in the compositions disclosed herein may vary. In certain examples, the material providing the active phase is preferably a monomeric, oligomeric or polymeric material that includes a porous network or that may be dimerized, oligomerized, polymerized or otherwise altered physically or chemically to include a porous network that may receive a fluid. In certain examples, the nature and type of the porous network may assist in controlling the degree and rate at which the compositions swell and/or deswell. Illustrative materials for providing an active phase include, but are not limited to, isoprene, polyisoprene, neoprene, isobutylene, polyisobutylene, butadiene, polybutadiene, styrene, polystyrene, styrene-butadiene, poly(styrene-butadiene), styrene-butadiene-styrene, poly(styrene-butadiene-styrene), ethylene, polyethylene, propylene, polypropylene, ethylene-propylene, poly(ethylene-propylene), polychloroprene, polysiloxane, chorosulfonated polyethylene, neoprene, ethylene-propylene-diene monomer (EPDM) rubber and mixtures or derivatives thereof. Additional suitable materials will be readily selected by the person of ordinary skill in the art, given the benefit of this disclosure.

In accordance with certain examples, some portion of the material that provides an active phase may be an elastomer. In other examples, the material providing the active phase may rendered elastomeric by inclusion of a suitable elastomer. Such elastomeric properties allow for expansion of the material during swelling while providing some structural integrity to the composition when it is used, for example, in a downhole tool to provide a seal in a wellbore. Illustrative elastomers for use as, or in, the materials in the compositions disclosed herein include, but are not limited to, natural rubber, synthetic rubber such as, for example, styrene-butadiene rubber (SBR), butadiene rubber, nitrile butadiene rubber and hydrogenated nitrile butadiene rubber (HNBR). Other natural and synthetic elastomers such as, for example, homo- or co-polymers of 1,3-butadiene, styrene, isoprene, isobutylene, 2,3-dimethyl-1,3-butadiene, acrylonitrile, ethylene, propylene and derivatives thereof may also be used as an active material. It will be within the ability of the person of ordinary skill in the art, given the benefit of this disclosure, to select additional suitable elastomeric materials for use in the compositions disclosed herein. In certain examples, the composition may comprise only the material that provides the active phase, whereas in other examples the composition may include a material that provides an active phase with the remainder of the composition including one or more other materials, fillers, particles or other materials. In some examples, two or more materials each of which includes an active phase may be used in the compositions. The active phases may have similar, but not the same, swelling characteristics. In some examples, one active phase may be responsive to swell in the presence of a polar fluid, whereas the other active phase may be responsive to swell in the presence of a non-polar fluid.

In accordance with certain examples, the material that provides the passive phase used in certain embodiments disclosed herein may be any material that can impart mechanical stability to the composition. In some examples, such materials may be monomeric, oligomeric, or polymeric. In other examples, the materials may take the form of an additive, fiber or other material that can provide structural rigidity and/or mechanical stability to the composition. Illustrative materials that provide a passive phase include but are not limited to, an acrylate, a polyacrylate, a urethane, a polyurethane, acrylonitrile-butadiene, a poly(acrylonitrile-butadiene), hydrogenated poly(acrylonitrile-butadiene), an epichlorohydrin, a polyepichlorohydrin, a sulfide, a polysulfide, a fluorinated polymer, fluoroelastomers (such as FKM or FFKM) and/or precursors, mixtures, or derivatives thereof. In some examples, the material that provides the passive phase may be, or may include, graphite, carbon black, silica, silanes or silicates. In certain examples, the material may take the form or a powder, aggregate, dispersion or other suitable form that may be combined with the material that provides the active phase.

In accordance with certain examples, various methods may be used to produce a composition comprising an active phase and passive phase. In some examples, the materials may be combined in a grinder or a mill and processed to a desired consistency, size or the like. In other examples, the materials may be combined mixing the materials during injection or streaming of them into a reactor chamber. In some examples, the compositions may be produced by combining the materials in a reaction vessel and inducing polymerization of the combined materials. Other additional methods may be used, for example, to produce the compositions. In certain embodiments, any method may be used to produce the compositions, for example, that provides a composition which includes a first phase that is responsive to swell and/or deswell and a second phase that is responsive to swell and/or deswell to a lesser degree than the first phase or to not substantially swell at all.

In accordance with certain examples, the compositions disclosed herein may also include, or be produced with, one or more stabilizers, cross-linkers, catalysts, initiators, retarders, fillers or the like. Illustrative materials include, but are not limited to, peroxides, catalysts and the like. In some examples, the compositions may be polymerized using light, heat or other suitable devices and methods.

In accordance with certain examples, the compositions disclosed herein may be a porous material such as a foam. As used herein, a foam refers to a material that is formed as a gas or liquid is trapped to provide a network of pores. In certain examples, the pores of the materials disclosed herein may receive a swelling fluid that causes the material to swell to a larger volume. The time to reach swelling equilibrium of a structure is generally proportional to the surface area of the polymer in contact with the fluid. Increasing the surface area, e.g., by using a polymeric foam, may decrease the time for the structure to swell. The surface area of the polymer in contact with the swelling fluid is generally a function of pore size and porosity. In certain examples, the foam may have a porosity of about 10% or more. In some examples, the volume of the foam may increase by about 40% or more after swelling, e.g., the volume increases by at least 50% more after swelling. In one illustration, the material may include a connected porosity that permits flowing of fluid rapidly from one pore to adjacent pores. In some examples, a material with a connected porosity may advantageously provide for further control of the kinetics, of the swelling, e.g., assists in controlling how fast the material swells. In other examples discussed herein, the composition may include one or more regions with selected regions, or all the regions, including a connected porosity.

In certain examples, the nature and properties of the swelling fluid may be used to control the degree to which the materials disclosed herein may expand. For example, certain materials may swell in the presence of a generally non-polar swelling fluid such as, for example, a hydrocarbon, an aromatic, an oil or the like, whereas other materials do not substantially swell in the presence of non-polar swelling fluids. In other examples, the material may swell in the presence of a polar fluid such as, for example, water, an alcohol, or the like. In some examples, a swelling fluid may be introduced to induce swelling of the composition, and the swelling fluid may be removed to induce deswelling of the composition. In other examples, a swelling fluid may be introduced to induce swelling, and the swelling fluid can be diluted by a secondary fluid to induce deswelling of the composition. Other methods of introducing and removing a swelling fluid will be readily selected by the person of ordinary skill in the art, given the benefit of this disclosure.

In accordance with certain examples, the degree and/or rate at which the overall composition swells in the presence of a swelling fluid may be controlled or tailored by including active and passive phases in the composition and by varying the amounts and/or ratios of such active and passive phases. For example, in embodiments where the composition is used to seal an annular space in a wellbore, the amount and type of active and passive phases for use in the composition may be selected to provide for effective sealing by swelling of the active phase while retaining structural integrity of the seal from the passive phase. The rate of swelling is proportional to the time to fill the pores of the material and the time for fluid in the material to diffuse throughout the material. An equilibrium state may be reached after a certain time at which the material has swollen. The exact time needed to swell and the resulting size of the swollen composition may vary depending on the chemical makeup of the composition and the amounts of the various components in the composition.

In accordance with certain examples, the rate and degree to which the compositions disclosed herein may swell and/or deswell may be further controlled by application of an external perturbation or stimulus. In certain examples, the stimulus may be applied for a selective time to control swelling and deswelling, whereas in other examples the stimulus may be continuously applied to control swelling and deswelling of the compositions. In general, suitable stimuli for controlling swelling and deswelling may be grouped into three categories: chemical stimulus, electrical stimulus and mechanical stimulus. As discussed above, in the absence of any external stimulus, the swollen volume and the swelling rate is generally determined by the interaction between the material and the swelling fluid. By applying a stimulus to the unswollen or swollen material, the degree and rate at which the material swells (or deswells) may be further controller or tuned, which increases the overall utility of the materials particularly in use in downhole applications to provide sealing of spaces.

In embodiments where a chemical stimulus is applied to the composition, the chemical stimulus may be effective to promote swelling at a faster or slower rate and/or to increase or decrease the average swollen volume. Further control or tuning of the swelling rate and/or swollen volume of the compositions disclosed herein through chemical stimulus is desirable as introduction of a chemical agent into the swelling fluid, or in addition to the swelling fluid, may be easily performed. In addition, the chemical stimulus may easily be removed by evacuation, flushing, absorption or other suitable devices and methods.

In certain examples, the exact chemical stimulus used may depend, at least in part, on the selected material or materials used in the composition. For example, polymeric materials may include ionizable groups that may be rendered charged or uncharged depending on the surrounding environment. A material that includes one or more carboxy groups (—COOH) may be exposed to a basic solution to activate the material and increase the swelling rate and the swelling volume. The same material may be exposed to an acidic solution to cause deswelling of the material. A material that includes one or more amino groups (—NH₂) may be exposed to an acidic solution to activate the material and increase the swelling rate and the swelling volume. The amino group-containing material may then be exposed to a basic solution to cause deswelling of the material. The exact pH used may be varied to control the rate of swelling and deswelling of these materials. In some examples, the pH of the solution may be adjusted in situ such that the swelling process may be controlled. For example, a material comprising carboxy groups may be exposed to a mildly basic solution, e.g., pH 8-9, to induce some swelling, and after a selected period, the pH of the chemical stimulus may be increased to a strongly basic solution, e.g., pH 13-14, to increase the rate of swelling. Such differential control of swelling may be useful, for example, where the compositions disclosed herein are used in packer assemblies and where the position of the packer assembly is being altered slightly to provide a better seal.

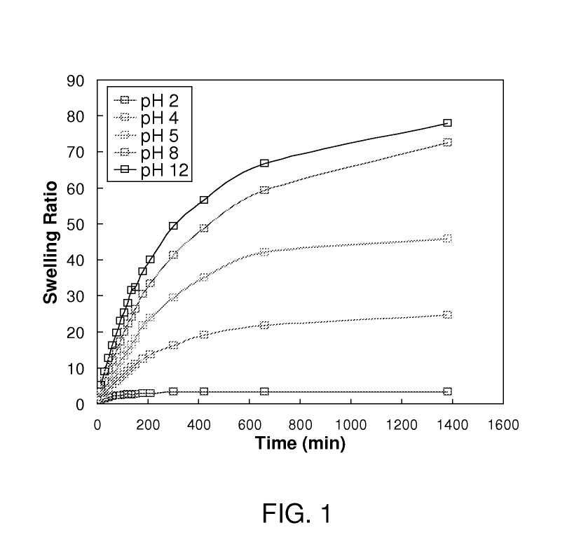

In accordance with certain examples, a graph showing the swelling ratio as a function of time of a carboxy-group containing material (polyacrylate gel) is shown in FIG. 1. The swelling ratio is the ratio of the final swollen mass of the material divided the unswollen mass of the material. Each of the initial and final mass was determined by weighing the samples during the swelling process. As shown in FIG. 1, at low pH (pH 2), the swelling ratio is very low (less than 5). As the pH is increased to pH 12, the swelling ratio increases to around 75. By exposing the material to a high pH, the degree to which the material swelled dramatically increased. Though the embodiment shown in FIG. 1 uses a chemical stimulus to increase the swelling ratio, a chemical stimulus may also be used to decrease the swelling ratio. Such a chemical stimulus to decrease the swelling ratio may be useful, for example, where the material or materials are used in a packer and it is desirable to remove or relocate the packer.

In accordance with certain examples, the chemical stimulus that is selected to control swelling and deswelling may be based on several factors including, but not limited to, the desired swelling rate, the desired swollen volume, the nature of the material to be swollen and the like. In certain examples, the chemical stimulus alters the ionic strength of the solution, e.g., is a salt solution. In other examples, the chemical stimulus may be a “getter” that is effective to absorb ions, such as protons, to alter the pH or ionic strength of the solution. In other examples, the chemical stimulus may be a fluid or solvent that has a different dielectric constant than a fluid used to swell the composition. For example, a secondary fluid may be introduced before, after or during swelling to alter the rate and degree to which the composition swells. In the alternative, a secondary fluid may be introduced to deswell the material. It will be within the ability of the person of ordinary skill in the art, given the benefit of this disclosure, to select suitable additional chemical stimuli for swelling and deswelling the compositions disclosed herein.

In embodiments where the compositions disclosed herein are used downhole, the chemical stimulus may be introduced downhole, for example, by pumping of a fluid downhole or by exposing the composition to the chemical stimulus prior to insertion into a wellbore. In some examples, the secondary fluid may be released proximate to the materials through tubing or the like. In certain examples where the secondary fluid is selected to deswell the material, the secondary fluid may be provided in excess to favor deswelling. The secondary fluid may be provided in a continuous or a pulsed manner, and the exact flow rate of the secondary fluid may vary but is preferably suitably high enough to induce deswelling within a reasonable period, e.g., less than one or two days in the case where the compositions are used in downhole tools.

In accordance with certain examples, an electrical stimulus may be applied to the composition to control swelling and/or deswelling. The electrical stimulus may be applied pre-swelling, during swelling or post-swelling to control the rate and/or degree of swelling. Application of an electric field may force fluid out of the material and decrease the swollen volume of the material. The exact amount of fluid forced out of the material depends, at least in part, on the nature of the fluid, the magnitude and/or orientation of the electric field and the type of interactions between the material and the fluid. In some examples, an electric field may be applied to a packer located downhole and comprising one or more of the compositions disclosed herein. By application of an electric field, any seal provided by the composition may be released from the deswelling thus allowing movement of the packer, e.g., movement to a different site in a wellbore or removal of the packer from a wellbore.

In accordance with certain examples, the electric field may be applied to the entire material or may be applied to a selected portion of the material. For example, in embodiments where the compositions disclosed herein are swollen and used to seal an annular space in a wellbore, a portion of the seal whose sealing integrity is less than desirable may be deswelled by application of the electric field to that portion. The electric field may be removed to allow the portion to swell again to attempt to provide a better seal. In other examples, the electric field may be applied to deswell a portion of the seal, and one or more additional stimuli, e.g., chemical or mechanical stimuli, may be applied during the reswelling process to control the rate and degree of swelling.

In some examples, the device used to apply an electric field to the composition to control swelling and/or deswelling may also be configured to apply other stimuli. Such additional stimuli include, but are not limited to, magnetic fields, chemical stimulus, mechanical stimulus and the like. In particular, a downhole tool may be designed such that one or more external stimuli may be applied downhole. In certain examples, an electric field may be applied by positioning a device, e.g., an electrode, proximate to one or more of the compositions disclosed herein and providing a current to the device to generate the electric field. In one embodiment, an electric field may be produced by passing a current through a conductive material adjacent to or near the composition. In other examples, an electric field may be produced by passing a current through a coil of wire surrounding a conductive object. In some examples, the current used to generate the electric field may be a direct current or an alternating current, and the current may be provided in a continuous, pulsed or other manner to provide a desired electric field shape and strength.

In certain examples, the exact magnitude of the electric field may vary, and in some examples, the electric field strength may be between about 10 V/m and about 4000 V/m, It will be recognized by the person of ordinary skill in the art, given the benefit of this disclosure, that the electric field strength may not be the same at different regions of the composition. In certain examples, the electric field may be configured such that a minimum electric field strength is present at substantially all regions of the composition, whereas in other examples some regions may have higher field strengths than other regions. In some examples, an electric field several fold in excess of what is needed to deswell the material may be applied to ensure sufficient deswelling. It will be within the ability of the person of ordinary skill in the art, given the benefit of this disclosure, to select suitable electric field strengths to deswell and/or swell the compositions disclosed herein.

In accordance with certain examples, a mechanical stimulus may be applied to the composition in order to control the rate of swelling (or deswelling) and/or the degree of swelling (or deswelling). The mechanical stimulus may be applied pre-swelling, during swelling, or post-swelling. The mechanical stimulus may be applied to reduce the amount of swelling or to control the rate at which the material or materials swell. As the strength of a mechanical stimulus is increased, e.g., an increase in the stretch, the material may swell to a lesser degree. At high levels of applied mechanical stimulus, the imposed deformation may result in little or substantially no swelling. Such application of a mechanical stimulus may be used to control the degree of swelling or to deswell the swollen material.

In certain examples, tensile and/or compressive stress may be applied to the materials to control the rate and degree of swelling. Either tensile stress, compressive stress or both may impose deformation on the material which may result in lower swelling ratios. Mechanical deformation may generally be higher for higher swelling ratios. Thus, mechanical stress may be used to deswell a swollen material or prevent a non-swollen material from swelling in the presence of a swelling fluid. The ability to control the materials by applying a mechanical stimulus provides significant advantages in positioning and repositioning packers and tools in a downhole setting. A downhole tool comprising one or more of the compositions disclosed herein may be positioned at a certain site and held in place by swelling of the material. The material may be deswelled by application of a mechanical stimulus to move the tool to a different site or to extract the tool from the wellbore. In addition, the material may be deswelled if the seal provided by the packer is not sufficient or suitable. In addition, by using the compositions disclosed herein to provide a swellable packer, the completion set-up may be significantly simplified. For example, the packers need not operate using hydraulic pressure to activate the packers, but, instead, the packer may be activated be controlling swelling of the material, e.g., the swelling of the material may be controlled to provide a desirable seal. Additional downhole uses and non-downhole uses of the compositions disclosed herein will be readily selected by the person of ordinary skill in the art, given the benefit of this disclosure.

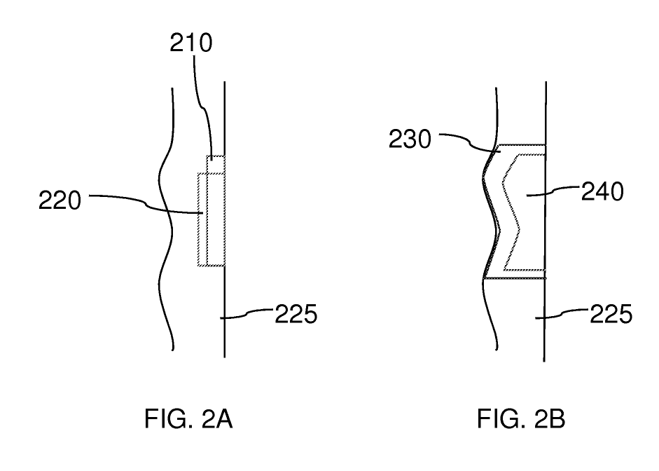

In accordance with certain examples, the swelling of the compositions disclosed herein may also be controlled by applying a strain to them pre-swelling, during swelling or post-swelling. In certain examples, materials which are pre-strained may be used in packers and downhole tools to provide control of the swelling process and the degree to which the materials swell. For example, materials may be pre-strained to reduce the degree to which the materials swell in the presence of a swelling fluid as compared to a comparable non-strained material. In the alternative, the materials may be subjected to a strain such that in the presence of a swelling fluid the materials swell to a lesser degree or not at all. Such control allows for positioning of a swellable packer downhole in the presence of a swelling fluid but preventing swelling until such a time when the packer is suitably positioned. The strain may be removed to allow the packer to swell and seal the space. An illustration of this concept is shown in FIGS. 2A and 2B. Referring to FIG. 2A, two swellable packers 210 and 220 are shown. The packer 210 has an applied strain which compresses the packer and increases its length but reduces its width. The packer 220 is shown as having no imposed strain. Post-swelling in the wellbore 225, the packer 220 is shown as swollen packer 230, and the strained packer 210 is shown as a strained swollen packer 240. The strain imposed on the packer 210 prevents the material from swelling to its non-strained equilibrium size, which allows for movement of the packer into or out of the wellbore 225. Once the packer is positioned suitably in the wellbore 225, the imposed strain may be removed to allow the packer 210 to swell to a size similar to that shown for the packer 230.

In accordance with certain examples, application of a strain to the compositions disclosed herein may substantially reduce the swelling ratio. For example, the materials disclosed herein may be used in a swellable packer that is permitted to swell to an equilibrium size to seal an annular space. It may be desirable to break the seal to move or remove the swellable packer from the annular space. This movement may be accomplished by imposing a strain on the swollen material to reduce the swelling ratio which would release the seal. The packer may be moved further into or out of the wellbore and the strain may be released to permit the material to swell and form a new seal at the new site.

In accordance with certain examples, many different devices may be used to apply a strain to the materials and to devices including the materials. In particular, any device that can induce a strain may be used. Illustrative devices include, but are not limited to, two or more concentric tubes with one tube made of or including, for example, a metal and the other tube made of or including, for example, a polymer. The tube made of a polymer may be extended and fixed on or to the metal tube. When a stimulus is released (or applied as the case may be), the polymeric tube may return to a no-strain position by sliding on the metallic tube to permit the material to swell. Additional suitable devices will be selected by the person of ordinary skill in the art, given the benefit of this disclosure.

In certain examples, the strain may be applied during the manufacture of the composition, whereas in other examples the strain may be applied during use of the composition. In embodiments where the strain is imposed during manufacture, the imposed strain may be removed during use to permit swelling of the material. Illustrative methods of removing the strain include, but are not limited to latching devices. It will be within the ability of the person of ordinary skill in the art, given the benefit of this disclosure, to select additional suitable methods and devices for removing strain from the compositions disclosed herein.

It will be understood by the person of ordinary skill in the art, given the benefit of this disclosure, that the illustrative external stimuli disclosed herein, e.g., the chemical, mechanical and electrical stimuli, may be applied to compositions that include an active phase and to compositions that include both an active phase and a passive phase. In addition, as discussed further below, internal constraints resulting from design of the materials, may be used in conjunction with the external stimuli.

In accordance with certain examples, the compositions disclosed herein may be polymeric and include two or more domains. As used herein “domain” refers to a block or unit of the polymer. In some examples, the composition includes at least a first domain and a second domain. In certain embodiments, the first domain may be effective to swell upon exposure to a swelling fluid. In other examples, the second domain may be effective to swell to a lesser degree than the first domain upon exposure to the swelling fluid. In some examples, steric constraints provided by other domains or groups in the polymeric material may assist in controlling the degree of swelling of the material. In certain examples, one or more non-swelling domains may be present to limit the volumetric expansion of the swelling domain. This internal control of the swelling ratio provides for additional tuning or control of the composition.

In certain examples, the first domain of the polymeric composition may be, or may include, a block copolymer. Block copolymers generally include segments or blocks of individual polymers covalently bound to each other in some type of arrangement, e.g., linear, branched or the like. The blocks of the polymers may be homopolymers or may be copolymers. In some examples, the block copolymers may be arranged as an AB block copolymer, an ABA block copolymer, an ABC block copolymer or a star block copolymer with A, B and C representing different types of blocks. In some examples, the polymeric material may include a plurality of domains with different domains having different arrangements, e.g., a first domain having an AB arrangement and a second domain having a star block arrangement. The exact material used in the blocks of the polymeric material may vary depending, for example, on the desired swelling, the desired mechanical properties and the intended use of the polymeric composition. In certain examples, the polymeric units of the block copolymer may independently be selected from a polystyrene, a polybutadiene, a polymerized isoprene, neoprene, a polyacrylate, and other polymeric materials. In certain examples, the polymeric material may include one or more additives such as, for example, graphite, carbon black, silica, silanes or silicates. Other suitable additives such as, for example, fibers, whiskers, fillers, particles and the like may also be included.

In accordance with certain examples, the first domain of the polymeric compositions may be effective to deswell in response to an external stimulus and in the presence of the swelling fluid. As discussed herein, one or more of a chemical, electrical or mechanical stimulus may be applied to transition the material from a swollen material to a non-swollen material. In some examples, the polymeric material may be pre-strained to control swelling of the first domain in the presence of the swelling fluid. Such pre-straining generally permits the polymeric composition to be surrounded by a suitable swelling fluid but to remain in a non-swollen state until the strain is removed. Other uses of the polymeric compositions will be recognized by the person of ordinary skill in the art, given the benefit of this disclosure.

In accordance with certain examples, one or more of the size, shape and volume fraction of the domains of the polymeric material may be selected in order to control the final mechanical properties, the rate at which the material swells and/or the degree to which the material swells. The shapes, sizes and the like of the polymeric compositions may be selected, for example, by controlling the self-assembly of the polymers. The properties provided by the resulting polymeric compositions are generally a function of the intrinsic properties of the individual domains, and the domain spatial arrangements, e.g., volume fraction, connectivity, shape and the size. The exact shape or form the domain may adopt may vary and illustrative shapes include, but are not limited to, spherical, cylindrical, gyroidal, lamellar or other suitable shapes. The size of the domains can vary, for example from about 10 cm to about 1 nm, more particularly about 1 cm to 1 nm, e.g., about 500 microns to about 1 nm. In some examples, different domains may be selected to have different shapes, sizes and arrangements such that certain domains are swellable, whereas other domains provide structural integrity to the overall polymeric composition. Such domains may provide for polymeric compositions that are particularly suitable for use in a downhole tool.

In accordance with certain examples, the compositions disclosed herein may include a suitable amount and type of active and passive phases or materials such that the mechanical strength increases post-swelling. While mechanical strength generally decreases as the composition swells, by selecting suitable amounts of the active and passive phases it may be possible to achieve better mechanical properties post-swelling than pre-swelling. Illustrative amounts to achieve such improved properties post-swelling generally depends on the type of active and passive phases present and the properties of the materials selected. In some examples a minor amount, e.g., 50% or less, of the material providing the active phase is present with the remainder of the composition comprising material that provides the passive phase. For example, styrene butadiene rubber (SBR) may be combined with HNBR by using 25% SBR and 75% HNBR or by using 40% SBR and 60% HNBR to provide a composition whose mechanical properties may improve post-swelling. Additional amounts and types of materials for use in compositions having improved mechanical properties post-swelling will be readily selected by the person of ordinary skill in the art, given the benefit of this disclosure.

In accordance with certain examples, a downhole tool is provided. In some examples, the downhole tool may be configured as a swellable packer. In this tool, the final diameter, where the seal is achieved, is reached by swelling of a material in the radial direction. A seal may be achieved by the expansion of the radius resulting from the axial compression of the compositions disclosed herein. The swellable packer may have no mechanical parts integrated because it may be activated by downhole fluids. This simplistic design is cheap and reliable and makes the packers very useful in extracting hydrocarbon fuels, such as natural gas, oil and the like. One problem with existing packers is that they may not be able to adequately withstand the amplitude of the differential pressure in the wellbore for a suitable period. During swelling of the elastomers, mechanical properties may be lost. The stability of the structure generally decreases and the differential pressure it can withstand decreases, which can result in loss of a seal.

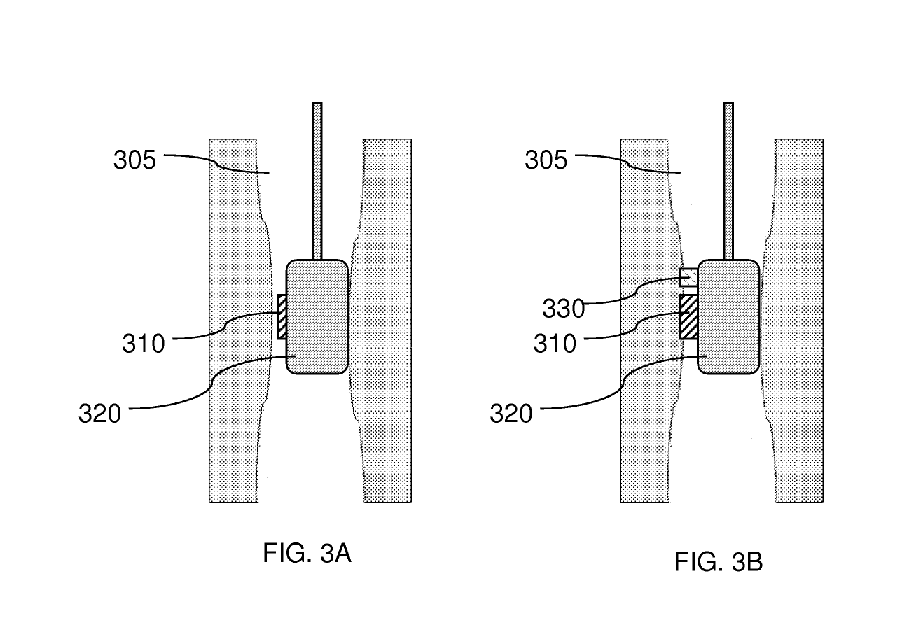

In certain examples, a downhole tool may include a swellable device comprising at least an active material effective to swell in response to exposure to a swelling fluid to provide a swollen device. In some examples, the active material may be further configured to deswell in response to an external stimulus applied to the swellable device. By using the materials and methods disclosed herein to control the rate and/or the degree at which the swellable device swells, a seal may be provided that has improved mechanical properties and can withstand variable fluid pressures in a wellbore. An illustration of a downhole tool is shown in FIGS. 3A and 3B. Referring to FIG. 3A, the downhole tool has been inserted into a wellbore 305. The downhole tool generally includes a swellable device 310, which is shown in a non-swollen state in FIG. 3A, and a support assembly 320 for positioning the swellable device 310. The support assembly may include an inflatable bladder that is operative to fill some of the space in the wellbore 305. During use of the downhole tool, the swellable device may be permitted to swell to seal the space, as shown in FIG. 3B, by exposing the swellable device 310 to a swelling fluid, which may be fluid already present in the wellbore 305. The rate and degree to which the swellable device swells may be controlled using the methods and devices described herein to control the rate and degree of swelling of materials including an active phase and/or a passive phase.

In certain examples, and as shown in FIG. 3B, the downhole tool may include a device 330 that is positioned proximate to the swellable device. In some examples, the device 330 may be configured to apply a stimulus to deswell the swollen device. In other examples, the device 330 may be configured to apply a chemical stimulus, an electrical stimulus or a mechanical stimulus to the swellable device 310 to control swelling or to deswell the swellable device 310. In some examples, the device may be configured to apply a strain to the swellable device 310 to keep the swellable device 310 in a non-swollen state in the presence of the swelling fluid. A stimulus may be applied, for example, to deswell the swellable device 310 such that the swellable device may be repositioned above or below the position shown in FIGS. 3A and 3B or such that the downhole tool may be removed from the wellbore 305.

In certain examples, the swellable device 310 may further comprise a passive phase that is configured to swell to a lesser degree than the active phase in the presence of the swelling fluid. The passive phase may be selected to provide mechanical strength to the swellable device 310 such that the swellable device 310 can withstand the differential pressures in the wellbore 305. The exact type and amount of the active and passive phases for use in the downhole tool may vary and in certain examples, the active phase may be a portion of an elastomer, a polymeric elastomer or other suitable materials that is responsive to swell in the presence of a swelling fluid. The passive phase may be any material, or portion thereof, that swells to a lesser degree than the active phase. In some examples, the passive phase may be selected to constrain swelling of the active phase to provide further control of the swelling process. Other features, such as meshes, scaffolding structures and the like that are commonly used in packer assemblies and other types of downhole tools may also be included in the downhole tools disclosed herein.

In accordance with certain examples, a method of controlling swelling of a swellable composition comprising an active material is provided. In certain examples, the method comprises applying a stimulus to the active material of the swellable composition in the presence of a swelling fluid to control the swelling of the swellable composition. As discussed herein, the stimulus may be used to control the rate and/or the degree at which the active material swells. Illustrative stimuli that are suitable for use include, but are not limited to, a chemical stimulus, an electrical stimulus, a mechanical stimulus, or other suitable stimulus that is effective to swell or deswell the composition. In some examples, the method may further comprise removing the stimulus to allow the active phase of the swellable composition to swell. Removal of the stimulus may be desirable, for example, where the swellable composition has been moved to a new site in a wellbore and a new seal is desired.

In accordance with certain examples, a method of controlling swelling of a swellable composition comprising an active material is provided. In some examples, the method comprises swelling a swellable material using a swelling fluid to provide a swollen material, and deswelling the swollen material by applying a stimulus to the swollen material. This method may be suitable, for example, where the composition is present in a sealing device of a downhole tool. The sealing device may be swollen to provide a seal, and when the downhole tool needs to be moved or removed, the stimulus may be applied to deswell the material to break the seal and permit movement. As discussed herein, the stimulus may be used to control the rate and/or the degree at which the active phase swells or deswells. Illustrative stimuli that are suitable for use include, but are not limited to, a chemical stimulus, an electrical stimulus, a mechanical stimulus, or other suitable stimulus that is effective to swell or deswell the composition.

In accordance with certain examples, a method of controlling swelling of a swellable composition comprising an active phase is disclosed. In some examples, the method comprises inducing strain in the swellable composition during manufacture of the swellable composition, and removing the strain in the swellable composition during use of the swellable composition to allow swelling of the swellable composition. As described herein, inducing a strain in the material generally prevents the material from swelling to an equilibrium state. Once the strain, or some portion of the strain, is removed, the material may swell to a larger degree. Such control allows for tuning of the swelling ratio of the material in use.

In accordance with certain examples, the compositions, devices and method disclosed herein may be used in the extraction of fuels, in fracturing and filtering applications and other structural devices such as, for example, self-healing structural components such as self-healing cement. In particular, the compositions disclosed herein may be used in any application where it may be desirable to change the overall volume of the composition while retaining mechanical features of the composition.

Certain specific examples are described below to further illustrate some of the many uses and properties of the technology disclosed herein.

### EXAMPLE 1

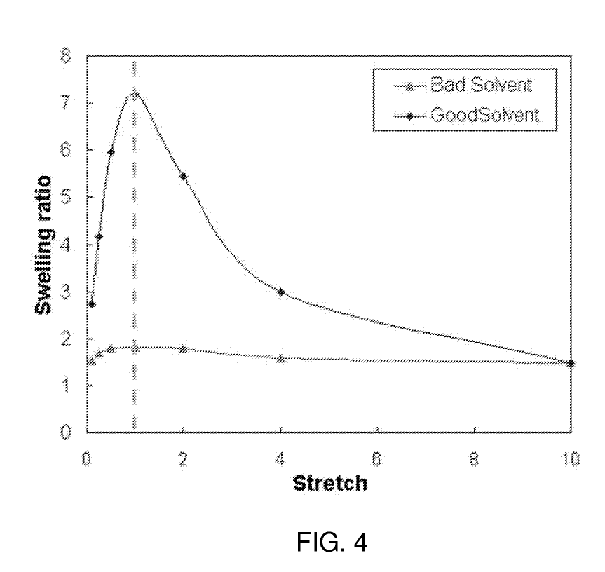

A composition comprising one phase was used for numerical computations. The modeling consisted of exposing the material to two different solvents. The “bad” solvent had a Flory-Huggins interaction parameter equal to 0.8, and the “good” solvent had a Flory-Huggins interaction parameter equal to 0.3. FIG. 4 shows the results of the modeling of swelling ratio versus stretch.

As shown in FIG. 4, the swelling ratio generally decreases with increasing imposed strain for both solvents. For the good solvent, at a constant stretch of about 1, the swelling ratio is about 7. For the bad solvent, at a constant stretch of about 1, the swelling ratio is about 1.8 or over three times less than the good solvent. Based on the results, at a constant imposed strain, the swelling ratio may be controlled by selection of a suitable solvent.

### EXAMPLE 2

Measurements on various materials were performed to determine the swelling ratios and strain while the material was swelling. The materials that were used were: (1) styrene butadiene rubber (SBR) (SBR 1502 commercially available from ISP or Lion copolymer) combined with HNBR (Therban® C4367 elastomer commercially available from Lanxess) using various amounts of SBR (25%, 50% and 75%) with the balance being HNBR); (2) neoprene including 30 phr carbon black; (3) neoprene including 50 phr carbon black; (4) natural rubber including 30 phr carbon black and (5) natural rubber including 50 phr carbon black. The SBR swells in oil, and the HNBR is relatively inert to the oil. All materials were blended and manufactured by Burke Industries, Inc. The strain was measured at 0%, 10%, 50% and 100% using a small setup that could fit in a pressure cell. The setup was designed to be able to stretch samples, following the ASTM standard D1708-2a “Standard Test Method for Tensile Properties of Plastics By Use of Microtensile Specimens (2002).” The samples were then submerged in IRM 903 reference oil (commercially available from R.E. Carroll) for 2 hours at 150° C. in the pressure cell. At the end of the test, if the linear swelling factor is higher than the imposed strain, the sample may have buckled in its setup. Each of the materials was swollen in oil (IRM 903). The results are shown graphically in FIG. 6. At a strain above about 20-25%, the swelling ratio of the materials was substantially constant indicating an imposed strain may be used to control the swelling ratio.

Stiffness measurements were also performed by performing uniaxial tensile tests, on an INSTRON 5569 machine using ASTM standard D1708-2a. For both 25% and 50% SBR compositions the failure strain and stress were higher for the swollen polymer (which is in some sense counter-intuitive, since the swollen polymer can be generally expected to be weaker). The stiffness measurements showed that the composite stiffness actually increased with swelling for the 25% SBR. Thus, in this case, the swollen structure was stronger post-swelling than pre-swelling. For the 50% SBR composite, the post-swelling stiffness was similar to that before swelling, i.e. the property reduction was minimal. The relatively low property loss for the 25% and 50% SBR may be explained in terms of effective confinement introduced by the non-swelling HNBR. As the SBR part of the composition is exposed to the oil medium, it swells locally. But the SBR swelling is constrained by the HNBR phase that forms a continuous matrix. This constraint limits both the swelling volume of the composition and the reduction in properties of the swollen composition.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

What is claimed is:

1. A swellable composition comprising:
an active phase responsive to swell upon exposure to a swelling fluid;
a passive phase responsive to swell to a lesser degree than the active phase upon exposure to the swelling fluid; and
in which at least the active phase of the swellable composition is effective to swell or deswell in response to an applied stimulus in the presence of the swelling fluid.

2. The swellable composition of claim 1, in which the active phase comprises at least one elastomer.

3. The swellable composition of claim 1, in which the passive phase is selected to provide structural integrity to the composition after swelling of the active phase.

4. The swellable composition of claim 1, in which the active phase comprises one or more of neoprene, styrene butadiene rubber, ethylene-propylene-diene monomer rubber or natural rubber.

5. The swellable composition of claim 1, in which the passive phase comprises one or more of hydrogenated butadiene rubber, homo- or co-polymers of 1,3-butadiene, styrene, isoprene, isobutylene, 2,3-dimethyl-1,3-butadiene, acrylonitrile, ethylene, propylene, fluoroelastomers or derivatives thereof.

6. The swellable composition of claim 1, in which the composition is effective to swell in the presence of a polar swelling fluid or a non-polar swelling fluid.

7. The swellable composition of claim 1, in which the active phase is effective to deswell in response to a chemical stimulus, a mechanical stimulus or an electrical stimulus.

8. A swellable composition effective to remain deswelled in the presence of a swelling fluid, the composition comprising a pre-strained active phase that is responsive to swell in a non-strained state to provide a swollen composition.

9. The swellable composition of claim 8, further comprising a passive phase effective to swell to a lesser degree than the active phase in its non-strained state.

10. The swellable composition of claim 8, in which the pre-strained active phase comprises an elastomer that has been strained during production of the elastomer to provide the pre-strained active phase.

11. The swellable composition of claim 8, in which the swellable composition swells or deswells in response to a chemical stimulus, a mechanical stimulus or an electrical stimulus.

12. A composition effective to swell in response to exposure to a swelling fluid to provide a swollen composition, the swollen composition effective to deswell in response to an external stimulus applied to the swollen composition in the presence of the swelling fluid.

13. The composition of claim 12, in which the composition comprises an active phase whose swelling ratio increases in response to exposure of the swelling fluid.

14. The composition of claim 13, further comprising a passive phase whose swelling ratio increases by a lower amount in the presence of the swelling fluid than the increase in the swelling ratio of the active phase.

15. The composition of claim 14, in which the active phase is effective to deswell in response to a chemical stimulus, a mechanical stimulus or an electrical stimulus.

16. A composition comprising at least a first domain effective to swell upon exposure to a swelling fluid and at least a second domain effective to swell to a lesser degree than the first domain upon exposure to the swelling fluid.

17. The composition of claim 16, in which the first domain is one or more blocks of a block copolymer.

18. The composition of claim 17, in which the first domain is effective to deswell in response to an external stimulus and in the presence of the swelling fluid.

19. The composition of claim 18, in which the external stimulus is a chemical stimulus, an electrical stimulus, or a mechanical stimulus.

20. A downhole tool comprising:
a swellable device comprising at least an active phase effective to swell in response to exposure to a swelling fluid to provide a swollen device, the active phase further configured to deswell in response to an external stimulus applied to the swellable device; and
a support assembly coupled to the swellable device.

21. The downhole tool of claim 20, further comprising an inflatable bladder coupled to the support assembly.

22. The downhole tool of claim 21, further comprising a device configured to apply the external stimulus to deswell the swollen device.

23. The downhole tool of claim 22, in which the device is configured to apply a chemical stimulus, an electrical stimulus or a mechanical stimulus.

24. The downhole tool of claim 22, in which the device is configured to apply a strain to the swellable device to keep the swellable device in a non-swollen state in the presence of the swelling fluid.

25. The downhole tool of claim 20, in which the swellable device further comprises a passive phase that is configured to swell to a lesser degree than the active phase in the presence of the swelling fluid.
